(19) United States
(12) Patent Application Publication
(10) Pub. No.: US 2020/0246943 A1
(43) Pub. Date: Aug. 6, 2020

(54) SOCKET STRUCTURE WITH ONLY A SINGLE POSITIONING MEMBER

(71) Applicant: GUOCHANG COLD FORGING CO., LTD., Taichung City (TW)

(72) Inventor: Ting-Wei CHU, Taichung City (TW)

(21) Appl. No.: 16/845,072

(22) Filed: Apr. 10, 2020

Related U.S. Application Data
(63) Continuation-in-part of application No. 15/784,159, filed on Oct. 15, 2017.

(51) Int. Cl. B25B 13/10; B25B 23/00

(52) U.S. Cl. CPC B25B 13/102; B25B 23/0035

(57) ABSTRACT

A socket structure with only a single positioning member includes: a sleeve body, a fitting member, a drive shaft, a first spring, a second spring and the positioning member. since the annular shoulder of the fitting member is abutted against by the annular protrusion of the drive shaft, the drive shaft can be prevented from detaching from the fitting member when pushed by the second spring. Besides, the single positioning member is provided for abutting against the positioning annular flange of the fitting member to prevent the fitting member from detaching from the sleeve body when pushed by the first spring. Therefore, the assembly of the socket structure can be completed by arrange one component (namely the positioning member) between the sleeve body, the fitting member, the drive shaft, the first spring, and the second spring, which reduces assembly and parts costs.

### CROSS REFERENCE TO RELATED APPLICATION

This application is a continuation in part of U.S. patent application Ser. No. 15/784,159, which claims the earlier filing date of Oct. 15, 2017, the entire specification of which is incorporated herein by reference.

### BACKGROUND

### Field of the Invention

The present invention relates to a socket structure, and more particularly to a socket structure having multiple specifications and only a single positioning member.

### Related Prior Art

The general sleeve can only lock a single size screw or nut, which is not conducive to the convenience of tool carrying when the worker is working. For this purpose, referring to FIG. 1, which is one of the drawings of US2012/0137837A1, showing a bolt-nut turning multi socket, which essentially comprises an outer sleeve 91, a middle sleeve 92, and an inner sleeve 93 stacked on top of each other in order. The outer sleeve 91 has a first working groove 911 for the screw or nut of a first size, and the middle sleeve 92 and the inner sleeve 93 have a second working groove 921 and a third working groove 931 respectively for the screw or nut of a second or third size, so as to provide a sleeve structure with multiple specifications, which can effectively reduce the number of tools that operators need to carry during working.

However, in addition to the outer sleeve 91, the middle sleeve 92, and the inner sleeve 93, this bolt-nut turning multi socket further includes: a spring 94 and a first annular fastener 95 provided between the outer sleeve 91 and the middle sleeve 92, a second spring 96 provided between the outer sleeve 91 and the inner sleeve 93, and a second annular fastener 97 provided between the middle sleeve 92 and the inner sleeve 93. Since the first annular fastener 95 prevents the middle sleeve 92 from detaching from the outer sleeve 91, and the second annular fastener 97 prevents the inner sleeve 93 from detaching from the middle sleeve 92, the annular fasteners are indispensable components. However, too many loop fasteners will not only cause time-consuming assembly, but also increase the cost of parts.

The present invention has arisen to mitigate and/or obviate the afore-described disadvantages.

### SUMMARY

One objective of the present invention is to provide a socket structure with only a single positioning member, which is a socket structure with multiple specifications, and can be assembled with only one positioning member, thereby reducing the cost of assembly and parts.

To achieve the above objective, a socket structure with only a single positioning member in accordance with the present invention comprises:

a sleeve body including a first working groove for engaging with a polygonal workpiece, a connecting groove opposite to the first working groove and for engaging with a driving tool, a first inner groove communicating with the first working groove, and a second inner groove communicating with the connecting groove and the first inner groove, wherein a width of the first inner groove is larger than that of the second inner groove, and a positioning annular groove is recessed in the first inner groove;

a fitting member movably disposed in the first working groove and the first inner groove, and including a front section corresponding to the first working groove and a rear section inserted in the first inner groove, wherein a length of the front section is shorter than a depth of the first working groove, the fitting member is provided at the front section with a second working groove having a width smaller than that of the first working groove, and provided at the rear section with a hole which is polygonal and communicates with the second working groove, the hole has an annular shoulder therein, and the rear section is provided with a positioning annular flange corresponding to the hole;

a first spring disposed in the first inner groove, and having one end elastically pressed against a stepped portion between the first inner groove and the second inner groove, and another end elastically pressed against the rear section of the fitting member, so as to make the front section of the fitting member be aligned with a mouth of the first working groove under normal circumstances;

a drive shaft having a polygonal shaft portion inserted in the hole of the fitting member, an annular protrusion connected to the polygonal shaft portion, and a protruding shaft portion connected to the annular protrusion, wherein the polygonal shaft portion extends out of the sleeve body and defines a gap with an inner surface of the second working groove under normal circumstances, and the annular protrusion has a first annular surface that is abutted against or moves away from the annular shoulder and a second annular surface that is opposite to the first annular surface;

a second spring having one end elastically abutted against a bottom of the second inner groove of the sleeve body, and another end sleeved on the protruding shaft portion of the drive shaft and elastically abutted against the second annular surface of the annular protrusion, so that the polygonal shaft portion partially protrudes from the second working groove under normal circumstances; and

a positioning member disposed in the positioning annular groove of the sleeve body and abutted against by the positioning annular flange of the fitting member to prevent the fitting member from detaching from the sleeve body;

the annular shoulder of the fitting member is abutted against by the annular protrusion of the drive shaft, so as to prevent the drive shaft from detaching from the fitting member when pushed by the second spring, the positioning member is provided for abutting against the positioning annular flange of the fitting member to prevent the fitting member from detaching from the sleeve body when pushed by the first spring.

The present invention is characterized in that: since the annular shoulder of the fitting member is abutted against by the annular protrusion of the drive shaft, the drive shaft can be prevented from detaching from the fitting member when pushed by the second spring. Besides, the single positioning member is provided for abutting against the positioning annular flange of the fitting member to prevent the fitting member from detaching from the sleeve body when pushed by the first spring. Therefore, the assembly of the socket structure with only the single positioning member can be completed by arrange one component (namely the positioning member) between the sleeve body, the fitting member, the drive shaft, the first spring, and the second spring, which reduces assembly and parts costs.

Preferably, the positioning annular flange of the sleeve body has a first annular surface that abuts against the positioning member under normal circumstances, and a second annular surface which is inclined and opposite to the first annular surface.

To achieve the above objective, the present invention further provides a socket structure with only a single positioning member, which comprises:

a sleeve body including a first working groove for engaging with a polygonal workpiece, a connecting groove opposite to the first working groove and for engaging with a driving tool, a first inner groove communicating with the first working groove, and a second inner groove communicating with the connecting groove and the first inner groove, wherein a width of the first inner groove is larger than that of the second inner groove, and a positioning annular flange is formed in the first inner groove;

a fitting member movably disposed in the first working groove and the first inner groove, and including a front section corresponding to the first working groove and a rear section inserted in the first inner groove, wherein a length of the front section is shorter than a depth of the first working groove, the fitting member is provided at the front section with a second working groove having a width smaller than that of the first working groove, and provided at the rear section with a hole which is polygonal and communicates with the second working groove, the hole has an annular shoulder therein, and the rear section is provided with a positioning annular groove corresponding to the hole;

a first spring disposed in the first inner groove, and having one end elastically pressed against a stepped portion between the first inner groove and the second inner groove, and another end elastically pressed against the rear section of the fitting member, so as to make the front section of the fitting member be aligned with a mouth of the first working groove under normal circumstances;

a drive shaft having a polygonal shaft portion inserted in the hole of the fitting member, an annular protrusion connected to the polygonal shaft portion, and a protruding shaft portion connected to the annular protrusion, wherein the polygonal shaft portion extends out of the sleeve body and defines a gap with an inner surface of the second working groove under normal circumstances, and the annular protrusion has a first annular surface that is abutted against or moves away from the annular shoulder and a second annular surface that is opposite to the first annular surface;

a second spring having one end elastically abutted against a bottom of the second inner groove of the sleeve body, and another end sleeved on the protruding shaft portion of the drive shaft and elastically abutted against the second annular surface of the annular protrusion, so that the polygonal shaft portion partially protrudes from the second working groove under normal circumstances; and

the positioning member disposed in the positioning annular groove of the fitting member and abutted against by the positioning annular flange of the sleeve body to prevent the fitting member from detaching from the sleeve body;

the annular shoulder of the fitting member is abutted against by the annular protrusion of the drive shaft, so as to prevent the drive shaft from detaching from the fitting member when pushed by the second spring, the positioning member is provided for abutting against the positioning annular flange of the sleeve body to prevent the fitting member from detaching from the sleeve body when pushed by the first spring.

Preferably, the positioning annular flange of the sleeve body has a first annular surface that abuts against the positioning member under normal circumstances, and a second annular surface which is inclined and opposite to the first annular surface.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is one of the drawings of US2012/137837A1;

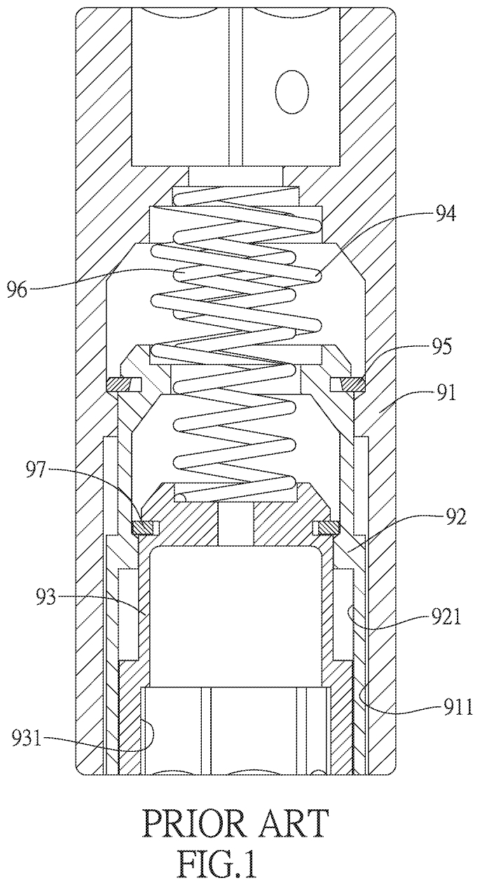

FIG. 2 is a schematic perspective view of a first embodiment of a socket structure with only a single positioning member according to the present invention;

FIG. 3 is an exploded perspective view of the first embodiment of the socket structure of the present invention;

FIG. 4 is a schematic cross-sectional view of a normal state of the first embodiment of the present invention;

FIG. 5 is a schematic cross-sectional view of the first embodiment of the present invention, showing the pressing of the drive shaft to expose the second working groove;

FIG. 6 is a schematic cross-sectional view of the first embodiment of the present invention, showing the pressing of the drive shaft and the fitting member to expose the first working groove;

FIG. 7 is a schematic cross-sectional view of another use state of the first embodiment of the present invention;

FIG. 8 is a schematic sectional view of a second embodiment of the present invention; and

FIG. 9 is a schematic cross-sectional view of the second embodiment of the present invention, showing the pressing of the drive shaft and the fitting member to expose the first working groove.

### DETAILED DESCRIPTION

The present invention will be clearer from the following description when viewed together with the accompanying drawings, which show, for purpose of illustrations only, the preferred embodiment in accordance with the present invention.

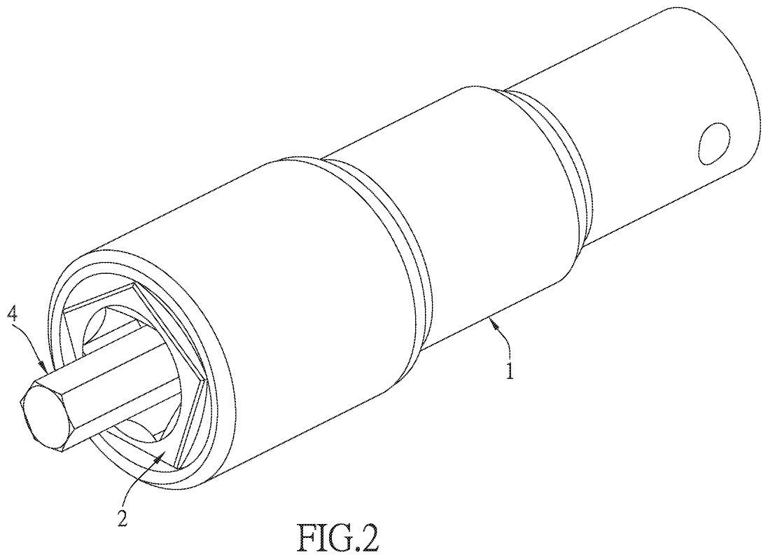

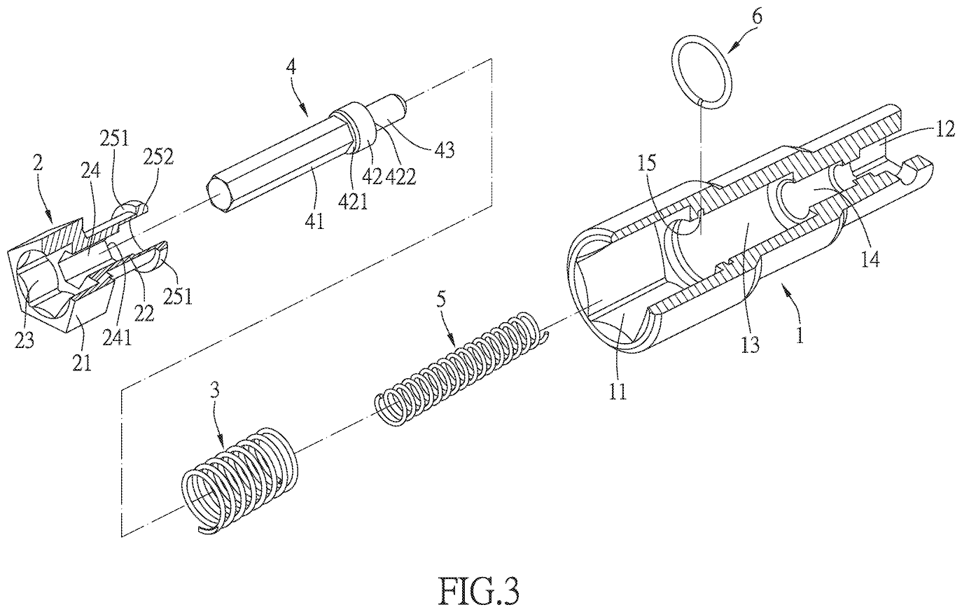

Referring to FIGS. 2-4 and 7, a socket structure with only a single positioning member provided by the first embodiment of the present invention essentially comprises: a sleeve body 1, a fitting member 2, a drive shaft 4, a first spring 3, a second spring 5, and the positioning member 6.

The sleeve body 1 has a first working groove 11 for engaging with a polygonal workpiece 7, a connecting groove 12 opposite to the first working groove 11 and for engaging with a driving tool (not shown), a first inner groove 13 communicating with the first working groove 11 and a second inner groove 14 communicating with the connecting groove 12 and the first inner groove 13. A width of the first inner groove 13 is larger than that of the second inner groove 14, and a positioning annular groove 15 is recessed in the first inner groove 13.

The fitting member 2 is movably disposed in the first working groove 11 and the first inner groove 13, and includes a front section 21 corresponding to the first working groove 11 and a rear section 22 inserted in the first inner groove 13. The length of the front section 21 is shorter than the depth of the first working groove 11, and the fitting member 2 is provided at the front section 21 with a second working groove 23 having a width smaller than that of the first working groove 11, and provided at the rear section 22 with a hole 24 which is polygonal and communicates with the second working groove 23. The hole 24 has an annular shoulder 241 therein, and the rear section 22 is provided with a positioning annular flange 25 corresponding to the hole 24. In this embodiment, the positioning annular flange 25 has a first annular surface 251 and a second annular surface 252 which is inclined and opposite to the first annular surface 251.

The first spring 3 is disposed in the first inner groove 13, and has one end elastically pressed against a stepped portion between the first inner groove 13 and the second inner groove 14, and another end elastically pressed against the rear section 22 of the fitting member 2, so as to make the front section 21 of the fitting member 2 be aligned with a mouth of the first working groove 11 under normal circumstances.

The drive shaft 4 has a polygonal shaft portion 41 inserted in the hole 24 of the fitting member 2, an annular protrusion 42 connected to the polygonal shaft portion 41, and a protruding shaft portion 43 connected to the annular protrusion 42. In this embodiment, the polygonal shaft portion 41 extends out of the sleeve body 1 and defines a gap H with the inner surface of the second working groove 23 under normal circumstances, and the annular protrusion 42 has a first annular surface 421 that is abutted against or moves away from the annular shoulder 241 and a second annular surface 422 that is opposite to the first annular surface 421.

The second spring 5 has one end elastically abutted against the bottom of the second inner groove 14 of the sleeve body 1, and another end sleeved on the protruding shaft portion 43 of the drive shaft 4 and elastically abutted against the second annular surface 422 of the annular protrusion 42, so that the polygonal shaft portion 41 can partially protrude from the second working groove 23 under normal circumstances.

The positioning member 6 is a C-shaped buckle disposed in the positioning annular groove 15 of the sleeve body 1 and is abutted against by the positioning annular flange 25 of the fitting member 2 to prevent the fitting member 2 from detaching from the sleeve body 1.

Since the annular shoulder 241 of the fitting member 2 is abutted against by the annular protrusion 42 of the drive shaft 4, the drive shaft 4 can be prevented from detaching from the fitting member 2 when pushed by the second spring 5. Besides, the single positioning member 6 is provided for abutting against the positioning annular flange 25 of the fitting member 2 to prevent the fitting member 2 from detaching from the sleeve body 1 when pushed by the first spring 3. Therefore, the assembly of the socket structure can be completed by arrange one component (namely the positioning member 6) between the sleeve body 1, the fitting member 2, the drive shaft 4, the first spring 3, and the second spring 5, which reduces assembly and parts costs. That is, the present invention changes the structural design of the sleeve body 1, the fitting member 2, and the drive shaft 4, so that the linkage relationship between the three can be completed by a single positioning member 6, which really reduces assembly and parts costs.

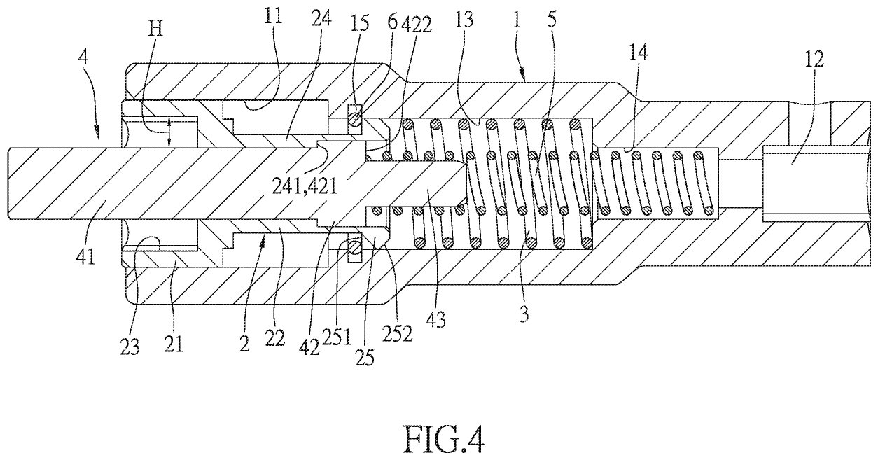

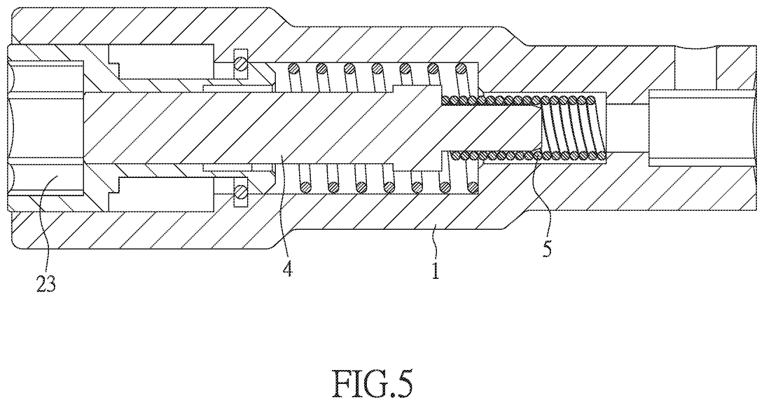

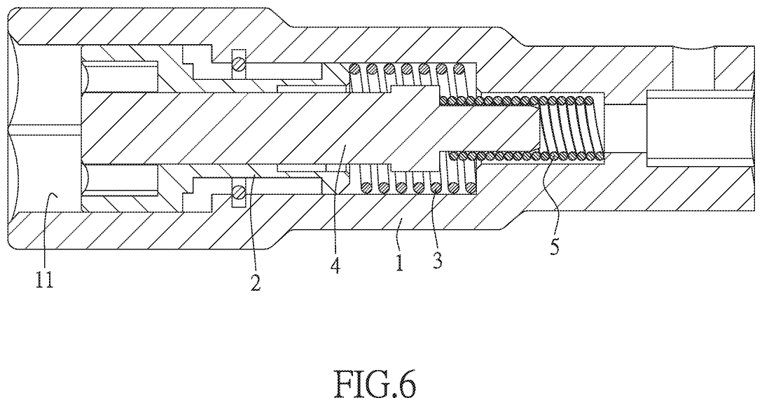

In addition, as shown in FIG. 4, when the drive shaft 4 and the fitting member 2 are not compressed, the fitting member 2 is located at the mounting of the first working groove 11, and the polygonal shaft portion 41 is extended out of the second working grooves 23 to allow the user to use the polygonal shaft portion 41 as a wrench tool. As shown in FIG. 5, when a workpiece conforms to the second working groove 23, the drive shaft 4 compresses the second spring 5 and retracts into the sleeve body 1 to expose the second working groove 23 to drive the workpiece. As shown in FIG. 6, when a workpiece conforms to the first working groove 11, the fitting member 2 and the drive shaft 4 compress the first spring 3 and the second spring 5 and retract into the sleeve body 1 to expose the first working groove 11 to drive the workpiece. According to this, the first working groove 11 and the second working groove 23 can each fit with screws and nuts of different specifications, and the telescopic drive shaft 4 can also be used as an internal hexagon wrench, which can achieve the advantage of integrating multi-standard locking heads in a single tool, thus effectively reducing the number of tools that the user has to carry during working.

It is worth mentioning that, because the hole 24 of the fitting member 2 is designed to have the annular shoulder 241; the annular protrusion 42 of the drive shaft 4 has the first annular surface 421 that is abutted against or moves away from the annular shoulder 241 and the second annular surface 422 that is opposite to the first annular surface 421, and the second spring 5 has another end elastically abutted against the second annular surface 422 of the annular protrusion 42. Therefore, the structural design of the annular protrusion 42 of the drive shaft 4 simultaneously has the following two functions:

First, by the design of the first annular surface 421 of the annular protrusion 42 of the drive shaft 4 and the annular shoulder 241 of the fitting member 2, the drive shaft 4 can be prevented from detaching from the second working groove 23 of the fitting member 2, so as to achieve the position-limiting function.

Second, the second annular surface 422 of the annular protrusion 42 is provided for another end of the second spring 5 to elastically press against, so that the polygonal shaft portion 31 of the drive shaft 4 can be extended out of the second working groove 23 of the fitting member 2 under normal circumstances, so as to achieve the pushing function.

According to this, the structural design of the annular protrusion 42 of the drive shaft 4 has the functions of position-limiting and pushing, so that the drive shaft 4 is relatively simple in structural design, and there is no need to perform grooving or drilling in the drive shaft 4, furthermore, the aforementioned two functions can be achieved without using latch members. In addition, due to the simple structure of the drive shaft 4, and the design of the sleeve body 1, the fitting member 2, the first spring 3, and the second spring 5, it is also relatively convenient to assemble. Therefore, the present invention can indeed make each component of the socket structure simpler and more convenient to assemble.

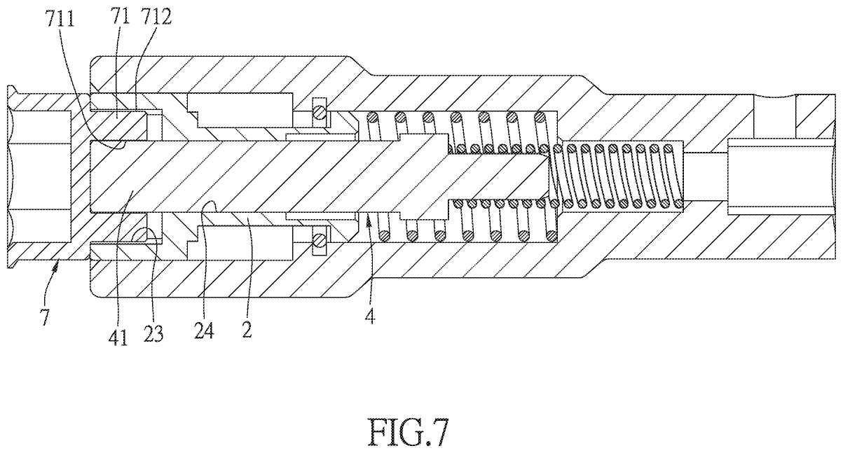

It is worth noting that, referring to FIGS. 4 and 7, since the drive shaft 4 has the polygonal shaft portion 41 inserted in the hole 24 of the fitting member 2, and the polygonal shaft portion 41 extends out of the sleeve body 1 and defines a gap H with the inner surface of the second working groove 23 under normal circumstances, when the driven portion 71 of the workpiece 7 has a polygonal inner hole 711 and a polygonal outer peripheral surface 712, the polygonal shaft portion 41 of the drive shaft 4 can be inserted and positioned in the inner hole 711 of the driven portion 71, and the second working groove 23 of the fitting member 2 can be sleeved on the outer peripheral surface 712 of the driven portion 71 of the workpiece 7. In this way, the bonding strength during driving can be increased to reduce the damage to the driven workpiece 7.

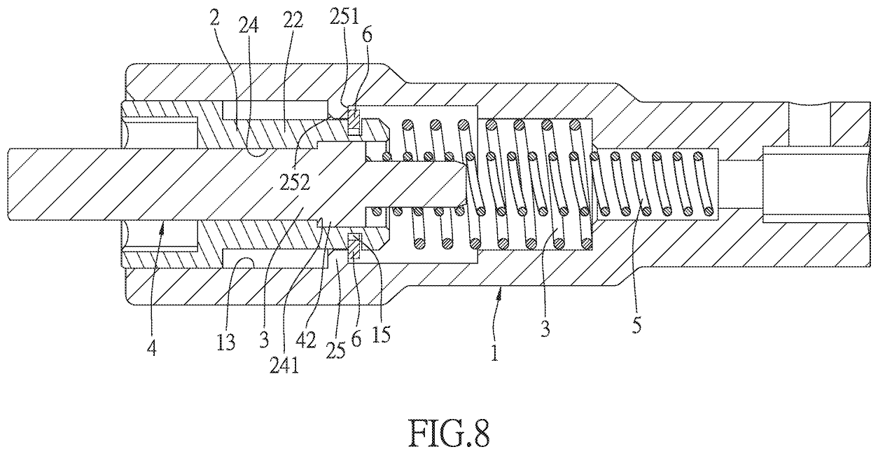

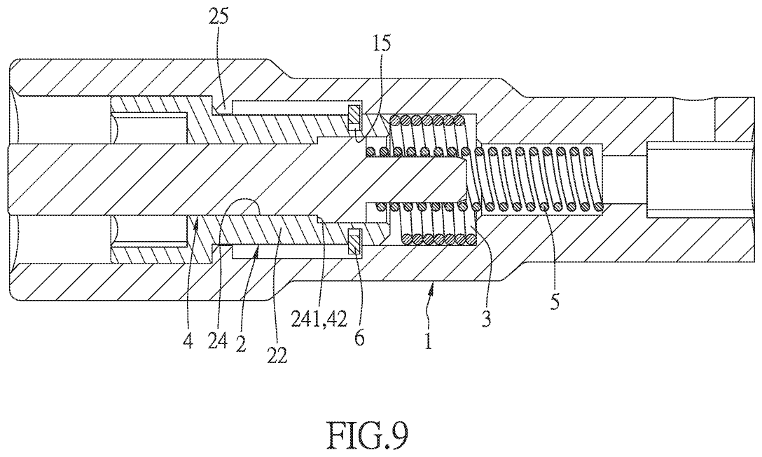

Referring to FIGS. 8 and 9, a socket structure with only a single positioning member provided by the second embodiment of the present invention also essentially comprises: a sleeve body 1, a fitting member 2, a drive shaft 4, a first spring 3, a second spring 5, and the positioning member 6. The configuration and effect of the second embodiment are the same as those of the first embodiment, so they will not be described in detail, and the second embodiment is different in the following respects:

The positioning annular flange 25 is provided on the sleeve body 1, that is, the first inner groove 13 of the sleeve body 1 is provided with a positioning annular flange 25. The positioning annular groove 15 is provided in the fitting member 2, that is, the rear section 22 of the fitting member 2 is provided with a positioning annular groove 15 corresponding to the hole 24. Therefore, the positioning member 6 is disposed in the positioning annular groove 15 of the fitting member 2 and is provided for the positioning annular flange 25 of the sleeve body 1 to abut against to prevent the fitting member 2 from detaching from the sleeve body 1.

Accordingly, the annular shoulder 241 of the fitting member 2 is provided for the annular protrusion 42 of the drive shaft 4 to abut against to prevent the drive shaft 4 from detaching from the fitting member 2 by the pushing of the second spring 5. Besides, the single positioning member 6 is provided for being stopped by the positioning annular flange 25 of the fitting member 2 to prevent the fitting member 2 from detaching from the sleeve body 1 when pushed by the first spring 3.

In addition, the positioning annular flange 25 of the sleeve body 1 has a first annular surface 251 that normally abuts against the positioning member 6 and a second annular surface 252 which is inclined and opposite to the first annular surface 251. Thereby, the second annular surface 252 having an inclined shape can be used to effectively push the positioning member 6 to make it shrink during assembly, which makes assembly easier.

While we have shown and described various embodiments in accordance with the present invention, it is clear to those skilled in the art that further embodiments may be made without departing from the scope of the present invention.

What is claimed is:

1. A socket structure with only a single positioning member comprising:
a sleeve body including a first working groove for engaging with a polygonal workpiece, a connecting groove opposite to the first working groove and for engaging with a driving tool, a first inner groove communicating with the first working groove, and a second inner groove communicating with the connecting groove and the first inner groove, wherein a width of the first inner groove is larger than that of the second inner groove, and a positioning annular groove is recessed in the first inner groove;
a fitting member movably disposed in the first working groove and the first inner groove, and including a front section corresponding to the first working groove and a rear section inserted in the first inner groove, wherein a length of the front section is shorter than a depth of the first working groove, the fitting member is provided at the front section with a second working groove having a width smaller than that of the first working groove, and provided at the rear section with a hole which is polygonal and communicates with the second working groove, the hole has an annular shoulder therein, and the rear section is provided with a positioning annular flange corresponding to the hole;
a first spring disposed in the first inner groove, and having one end elastically pressed against a stepped portion between the first inner groove and the second inner groove, and another end elastically pressed against the rear section of the fitting member, so as to make the front section of the fitting member be aligned with a mouth of the first working groove under normal circumstances;
a drive shaft having a polygonal shaft portion inserted in the hole of the fitting member, an annular protrusion connected to the polygonal shaft portion, and a protruding shaft portion connected to the annular protrusion, wherein the polygonal shaft portion extends out of the sleeve body and defines a gap with an inner surface of the second working groove under normal circumstances, and the annular protrusion has a first annular surface that is abutted against or moves away from the annular shoulder and a second annular surface that is opposite to the first annular surface;
a second spring having one end elastically abutted against a bottom of the second inner groove of the sleeve body, and another end sleeved on the protruding shaft portion of the drive shaft and elastically abutted against the second annular surface of the annular protrusion, so that the polygonal shaft portion partially protrudes from the second working groove under normal circumstances; and
the positioning member disposed in the positioning annular groove of the sleeve body and abutted against by the positioning annular flange of the fitting member to prevent the fitting member from detaching from the sleeve body;
the annular shoulder of the fitting member is abutted against by the annular protrusion of the drive shaft, so as to prevent the drive shaft from detaching from the fitting member when pushed by the second spring, the positioning member is provided for abutting against the positioning annular flange of the fitting member to prevent the fitting member from detaching from the sleeve body when pushed by the first spring.

2. The socket structure as claimed in claim 1, wherein the positioning annular flange of the sleeve body has a first annular surface that abuts against the positioning member under normal circumstances, and a second annular surface which is inclined and opposite to the first annular surface.

3. A socket structure with only a single positioning member comprising:
a sleeve body including a first working groove for engaging with a polygonal workpiece, a connecting groove opposite to the first working groove and for engaging with a driving tool, a first inner groove communicating with the first working groove, and a second inner groove communicating with the connecting groove and the first inner groove, wherein a width of the first inner groove is larger than that of the second inner groove, and a positioning annular flange is formed in the first inner groove;
a fitting member movably disposed in the first working groove and the first inner groove, and including a front section corresponding to the first working groove and a rear section inserted in the first inner groove, wherein a length of the front section is shorter than a depth of the first working groove, the fitting member is provided at the front section with a second working groove having a width smaller than that of the first working groove, and provided at the rear section with a hole which is polygonal and communicates with the second working groove, the hole has an annular shoulder therein, and the rear section is provided with a positioning annular groove corresponding to the hole;
a first spring disposed in the first inner groove, and having one end elastically pressed against a stepped portion between the first inner groove and the second inner groove, and another end elastically pressed against the rear section of the fitting member, so as to make the front section of the fitting member be aligned with a mouth of the first working groove under normal circumstances;
a drive shaft having a polygonal shaft portion inserted in the hole of the fitting member, an annular protrusion connected to the polygonal shaft portion, and a protruding shaft portion connected to the annular protrusion, wherein the polygonal shaft portion extends out of the sleeve body and defines a gap with an inner surface of the second working groove under normal circumstances, and the annular protrusion has a first annular surface that is abutted against or moves away from the annular shoulder and a second annular surface that is opposite to the first annular surface;
a second spring having one end elastically abutted against a bottom of the second inner groove of the sleeve body, and another end sleeved on the protruding shaft portion of the drive shaft and elastically abutted against the second annular surface of the annular protrusion, so that the polygonal shaft portion partially protrudes from the second working groove under normal circumstances; and
the positioning member disposed in the positioning annular groove of the fitting member and abutted against by the positioning annular flange of the sleeve body to prevent the fitting member from detaching from the sleeve body;
the annular shoulder of the fitting member is abutted against by the annular protrusion of the drive shaft, so as to prevent the drive shaft from detaching from the fitting member when pushed by the second spring, the positioning member is provided for abutting against the positioning annular flange of the sleeve body to prevent the fitting member from detaching from the sleeve body when pushed by the first spring.

4. The socket structure as claimed in claim 3, wherein the positioning annular flange of the sleeve body has a first annular surface that abuts against the positioning member under normal circumstances, and a second annular surface which is inclined and opposite to the first annular surface.
